(19) United States
(12) Patent Application Publication
(10) Pub. No.: US 2015/0058246 A1
(43) Pub. Date: Feb. 26, 2015

(54) SYSTEM, METHOD AND PERIPHERAL DEVICE

(71) Applicants: William L. Nail, III, Picayune, MS (US); Brooks Randall Wallace, Picayune, MS (US)

(72) Inventors: William L. Nail, III, Picayune, MS (US); Brooks Randall Wallace, Picayune, MS (US)

(21) Appl. No.: 14/464,686

(22) Filed: Aug. 20, 2014

Related U.S. Application Data
(60) Provisional application No. 61/867,846, filed on Aug. 20, 2013.

(51) Int. Cl. G06Q 10/08; G06Q 50/28; G06F 3/12

(52) U.S. Cl. CPC G06Q 10/0833; G06F 3/1287; G06Q 50/28; G06Q 10/0875
USPC 705/333; 358/1.15

(57) ABSTRACT

An improved system and method for tracking inventory or hauling events, such as debris removal loading and disposal events, are disclosed. Also disclosed is a peripheral printing device for use with a tablet computer, smart-phone, or other computing device. The peripheral printing device can be used with the improved system or method in the tracking of inventory or hauling events. Also disclosed is a method of communication between a host device and a peripheral device using audio port channels.

### CROSS-REFERENCES TO RELATED APPLICATIONS

This application claims the benefit of U.S. Provisional Application No. 61/867,846, filed Aug. 20, 2013, which is hereby incorporated herein by reference in its entirety.

### FIELD OF THE INVENTION

The present invention is generally directed toward a peripheral device for a tablet computer, smart-phone, or other portable web-enabled device. More particularly, the disclosed peripheral device may be used in a system and/or process to print and generate sales and delivery receipts, provide other transaction hard copies, or track inventory or hauling events, such as debris loading and disposal events.

### BACKGROUND OF THE INVENTION

A natural disaster often leaves a debris field in its wake. The clean-up and recovery process necessarily includes the removal of such debris. Local, state, and federal government agencies employ debris removal services to manage, load, haul, and dispose (dump) the debris from a natural disaster site. Debris removal service providers have employed carbon copy duplicates or similar kinds of document/paper systems to track debris as it is loaded, hauled, and disposed (dumped). The carbon copy duplicates and other paper systems used in the field are easily altered or otherwise amenable to fraudulent claims, such as weight of debris load, time/date or load, etc. Similar carbon copy duplicates and paper systems are used in other debris removal applications and other load hauling fields (debris from fire destruction, demolition, etc.), and these systems suffer from the same problems of potential for fraudulent claims. There is a need in the field for an improved system to manage and track debris removal loads from the point of loading to the point of dumping for better accountability and fraud prevention.

### SUMMARY OF THE INVENTION

Systems, methods, and peripheral devices for use with a tablet computer, smart-phone, or other computer device are described. A method for communicating between a peripheral device and a tablet computer, smart-phone, or other computer device is also described.

According to one aspect of the present invention, a peripheral printing device is disclosed. The peripheral printing device can be used as a peripheral device for a host device, wherein the host device is a tablet computer, smart-phone, laptop computer, PDA, or other portable computing device.

According to another aspect of the present invention, a method of printing using the peripheral printing device is disclosed.

According to another aspect of the present invention, a method of communication between a peripheral device, such as a peripheral printing device, and a host device, such as a tablet computer, smart-phone, laptop computer, PDA, or other portable computing device, is disclosed.

According to a further aspect of the present invention, a system for tracking an inventory of goods is disclosed. In some embodiments, tracking the removal and disposal of debris is provided. In other embodiments, tracking sales and delivery of goods is provided. In still other embodiments, tracking transactions by printing hardcopies of deposit or load tracking tickets is provided.

According to still yet another aspect of the present invention, software enabling communication between a peripheral device and a host device, wherein the host device has a proprietary/locked operating system, via an audio port and audio jack connection between said peripheral and host devices is disclosed.

### BRIEF DESCRIPTION OF THE DRAWINGS

Further advantages of the invention will become apparent by reference to the detailed description of preferred embodiments when considered in conjunction with the drawings:

FIG. 1 depicts a view of the front of a peripheral printing device when not connected to a tablet computer, smart-phone, or other portable web-enabled device.

FIGS. 2A & 2B depict a peripheral printing device with the top cover removed. FIG. 2A shows an elevation view of an embodiment of the peripheral printing device. FIG. 2B shows a perspective view of an embodiment of the peripheral printing device.

FIGS. 3A & 3B depict a peripheral printing device. FIG. 3A is an elevation view of one side of an embodiment of the peripheral printing device showing a headphone/audio jack for electrically connecting to a host device. FIG. 3B is an elevation view of an embodiment of the peripheral printing device physically attached to and with its audio jack plugged in an audio port of a host device.

FIG. 4 is an elevation view of the bottom of a peripheral printing device.

FIG. 5 is an elevation view of a second side of a peripheral printing device with a connection clamp for physically attaching the peripheral printing device to a host device.

FIGS. 6A & 6B depict a third side of a peripheral printing device. FIG. 6A shows the third side of the peripheral printing device, and FIG. 6B shows the third side of the peripheral printing device in which the peripheral printing device is physically attached to a host device.

FIGS. 7A & 7B depict perspective views of the top and bottom, respectively, of a peripheral printing device physically attached to a host device. FIG. 7A depicts a top perspective view of a peripheral printing device together with a load ticket having a confirmation code printed on one side of the load ticket. FIG. 7B depicts a bottom perspective view of a peripheral printing device.

FIGS. 8A-D depict deposit or load tickets for use in conjunction with a peripheral printing device and an electronic debris management system. FIG. 8A depicts the top side of the load ticket. FIG. 8B depicts the barcode side of the load ticket. FIG. 8C depicts the barcode side of the load ticket that having a load confirmation code printed on the bottom edge of the ticket. FIG. 8D depicts the top side of a load ticket that having a disposal confirmation code printed on the top edge of the ticket.

FIG. 9 is a diagram of an embodiment of a method of communicating between a peripheral device and a host device.

FIG. 10 depicts an exemplary embodiment of a system and method for managing and tracking load events, for example in a debris removal and disposing operation after an event, such as a natural disaster.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

Printers are plagued with moving part jams and failures. Mobile printers are especially subject to harsh conditions that aggravate these tendencies. One way of reducing moving parts is to use thermal print technology. Unfortunately, thermal printing is energy intensive, requires special paper, and the printed text will lose contrast with time. Conventional small printers use a roll of paper which reduces jamming but retains several moving parts that can become dirty and wear out. Roll paper increases the size and weight of the printer. The present inventions overcome all of these shortcomings in the prior art.

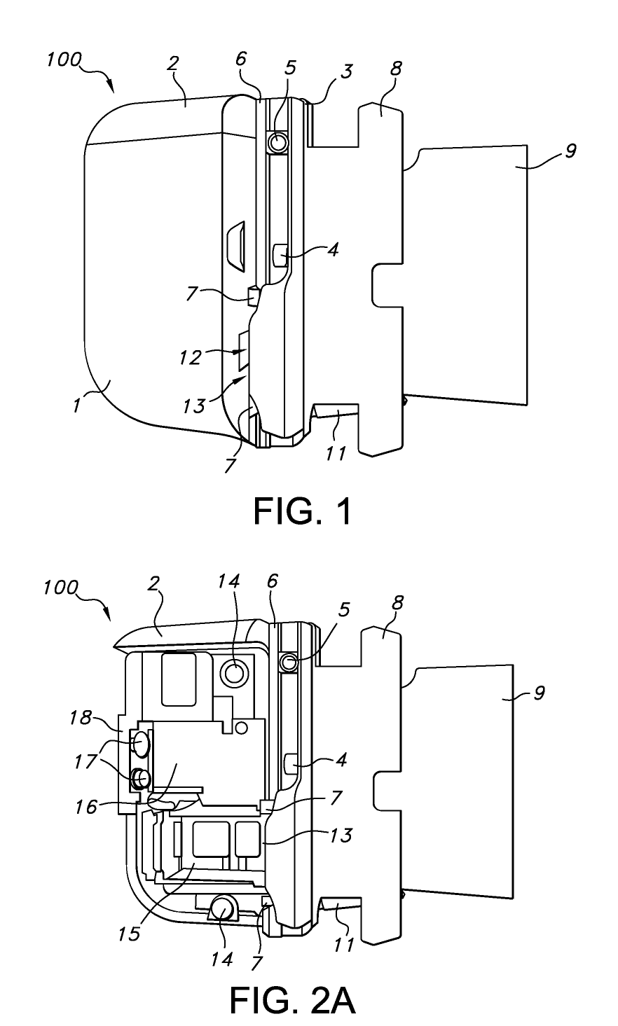

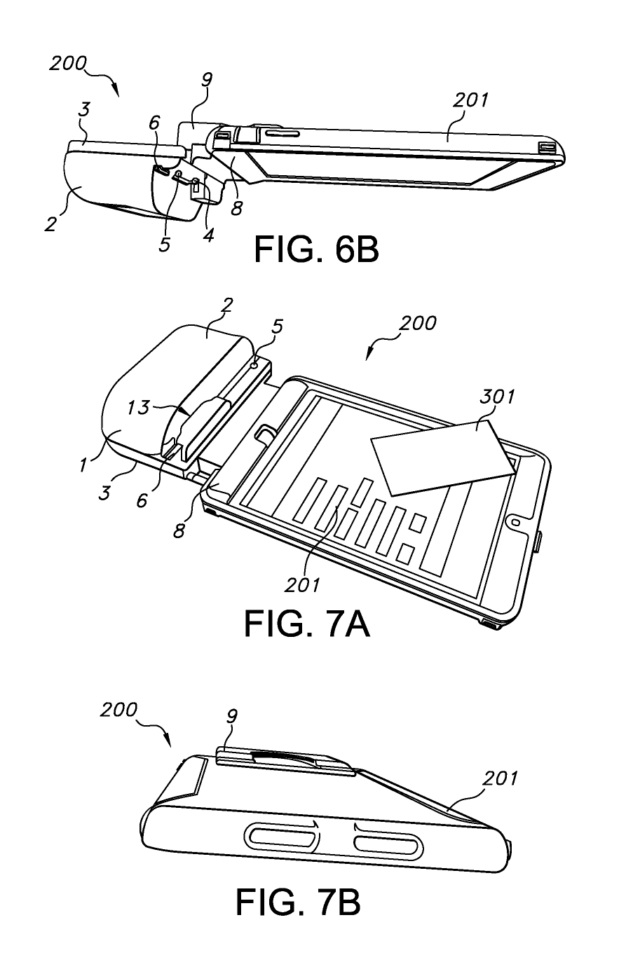

Referring to the drawings, FIGS. 1-7 illustrate an exemplary embodiment of the peripheral device that overcomes these and other shortcomings of the prior art. In a preferred embodiment, the peripheral device is configured to be a peripheral printing device 100 for a portable computing host device, such as a tablet computer, smart-phone, PDA, laptop computer, or other portable web-enabled device. It should be understood that a web-enabled device includes any device that is capable of making a networked communication connection, including the Internet, MMS, and/or intranets. The peripheral printing device 100 preferably has no paper feed mechanism, prints on a wide range of paper thicknesses, and uses a minimum number of sensing elements 7 to detect printing medium and speed through the peripheral printing device 100. The peripheral printing device 100 in FIG. 1 has a top cover 1, and top body member 2, and a bottom body member 3 comprising a peripheral device body. The peripheral printing device 100 is powered on and off by depressing an ON/OFF power button 4. An LED indicator 5 flashes slowly when the peripheral printing device 100 is powered on. The peripheral printing device 100 further comprises an upper connection member 8 and a lower connection member 9 for physically attaching the peripheral printing device 100 to a host device. For electrical communication with a host device, the peripheral printing device 100 further comprises an electrical and data connector 11. In preferred embodiments, the electrical and data connector is an audio jack 11. Other electrical and data connector 11 known in the field are also fully contemplated and intended to be capable of use with some embodiments, including all known USB connectors, Firewire connectors, and other data and electric cables.

The peripheral printing device 100 has an alignment path 6 that allows the user to place print media, such as deposit or load tracking tickets, in the path of the print head 12. The alignment path 6 precisely fixes the relationship of the peripheral printing device 100 to the media, regardless of the thickness. The alignment path 6 is designed to provide motion resistance as feedback to the user. The alignment path 6 is preferably visibly distinct from the rest of the peripheral printing device 100 to aid hand-eye coordination of the user when feeding print media to the peripheral printing device 100. The alignment path 6 preferably has a distinct feel, such as an indention or groove, that allows print media alignment without observation. Users can use the peripheral printing device 100 with poor or no vision or visibility due to low light conditions.

The print media can pass through the print head area 13 with print head 12 in either direction along the alignment path 6 with the peripheral printing device 100 automatically adjusting the print order of the pixels, so that personal preference or specific use cases can dictate the orientation of printing. A plurality of print media sensors 7 placed at either side of the print head 12 detect the print media entering the printing area 13. Using algorithms embedded in the peripheral printing device 100 software and method, the printing head 12 begins printing when the print media arrives in front of the print head 12 and stops printing within preset distances traveled by the print media or margins determined on the fly as the print media passes the sensors 7.

Embedded algorithms within the peripheral printing device 100 software determine the speed at which the inkjets are fired at the print media. In one embodiment, the speed is constant and the user learns the range of print media speeds that result in the desired print size. In another embodiment, the printing speed is adjustable by the user. In a preferred embodiment, the print speed varies with the motion of the print media, adjusting automatically with the speed of the print media as it passes by the sensors 7 in the printing area 13. In more preferred embodiments, the printing speed further automatically adjusts to account for acceleration or deceleration of the print media as it passes by the sensors 7 in the printing area 13. While some embodiments include two sensors 7, other embodiments may include additional sensors 7 to improve dynamic speed adjustments or for other improvements in printing.

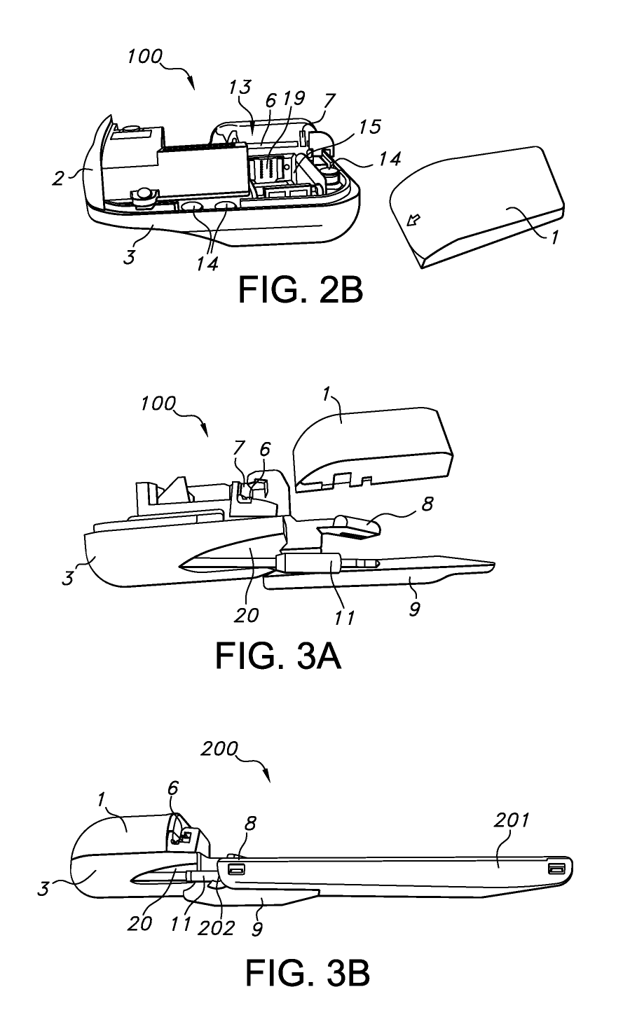

FIGS. 2A and 2B further show the peripheral printing device 100 in which the top cover 1 has been removed to expose the inner compartment. The top cover 1 is held to the peripheral printing device 100 by four magnet pairs 14. The peripheral printing device 100 inner compartment comprises a printer cartridge carrier cavity 15 and a battery cavity 16. In preferred embodiments, the peripheral printing device 100 uses a rugged replaceable industrial inkjet print cartridge (not shown) that includes one or more jets for each pixel in one dimension. A carrier that provides an electrical connection 19 holds the print cartridge in alignment in the printer cartridge carrier area 15. In preferred embodiments, the peripheral printing device 100 comprises its own onboard energy source, and in more preferred embodiments, the energy source is a nine (9) volt battery (not shown) making electrical connection with the peripheral printing device 100 at connection points 17 located on the battery wall 18. Other embodiments include a rechargeable battery (not shown). Still other embodiments receive energy directly from the host device via the electrical and data connector 11.

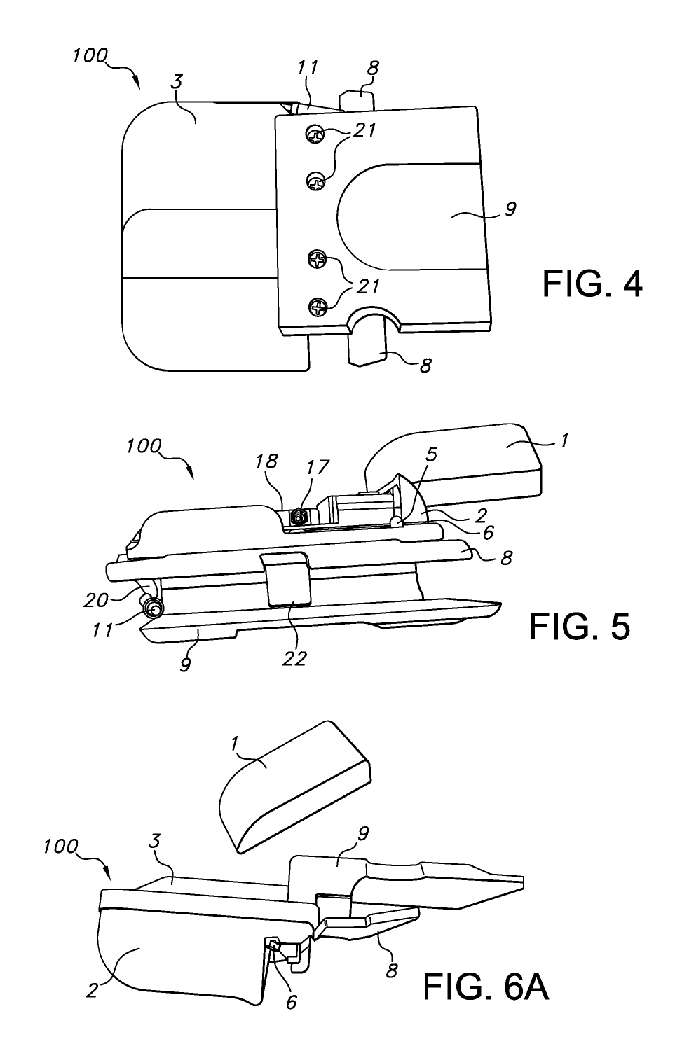

In FIG. 3A, the peripheral printing device 100 is further depicted in another view to better show the audio jack 11. The audio jack cable area 20 of bottom member 3 contains a cut out to allow access to the audio jack 11 and freedom of movement for plugging the audio jack 11 into the audio port 202 of a host device, as can be appreciated in FIG. 3B depicting the combined peripheral printing device physically attached to a tablet computer host device 200. The combined peripheral printing device physically attached to a tablet computer host device 200 is held together by upper connection member 8 and a lower connection member 9. FIG. 4 shows the underside of peripheral printing device 100, including four screws that secure upper connection member 8 and a lower connection member 9 to a connection member 22 (shown in FIG. 5). The screws can be loosened to remove lower connection member 9 and attach a host device 201 (shown in FIGS. 3B, 6B, 7A, and 7B).

In preferred embodiments, the peripheral printing device 100 comprises many power saving features. For example, the peripheral printing device 100 is designed to use very little power. The design allows for weeks of use from a single nine (9) volt battery. This eliminates the need for expensive rechargeable batteries as well as the associated problems of ensuring a full charge. As part of its power management, the peripheral printing device 100 sleeps when it is not in use after a certain delay. An easy access power button 4 wakes or sleeps the printer in a toggling fashion. The electronics of the peripheral printing device 100 are designed so that zero energy is used in sleep mode. The printer powers up within a fraction of a second, appearing to awake instantaneously to the user.

A high visibility energy efficient status bicolor LED 5 is used for indicating if the peripheral printing device 100 is asleep or awake. Green flashing slowly, indicates the peripheral printing device 100 is awake rather than asleep. A flashing rather than a steady state indicator further saves energy. The peripheral printing device 100 indicates it has data ready to print by flashing green more rapidly. A steady Green or Red LED while the media is passing through the print head 12 gives additional feedback to the user that the media is properly aligned and being fed at an acceptable rate. Rapid Red LED flashing at an irregular rate gives visual indication to the user of data transmission from the host. Periodic Red LED flashing mixed with the normal Green flashing indicates that the battery needs to be replaced soon. Optionally, the threshold voltage for battery replacement can be changed depending on the battery chemistry used. An on-board temperature sensor (not shown) can optionally be used to predict battery life more accurately, since many battery chemistries significantly reduce their output potential at cold temperatures. Battery voltage, percent depletion, or estimated time remaining can optionally print to a print media. Placing print media in the print path so that all sensors 7 sense print media when the device wakes, triggers a health monitoring report the next time print media is passed through the print area. Other useful information such as the current firmware version, time since last battery or ink cartridge change, highest and lowest temperature exposure, estimated remaining ink capacity can be reported by printing to a print media.

The print media sensors 7, are normally powered off even when the peripheral printing device 100 is awake. They are turned on periodically for a brief moment to check for the presence of print media, and then powered off again. Once print media is sensed, the sensors 7 are turned on and off more rapidly to precisely determine the print speed and direction. The peripheral printing device 100 is kept awake by either activity on its communication port or by sensing the presence of print media in its print path. The delay to sleep setting can be changed programmatically or by sending a certain code through the communication port 11/202. Depending on the application, the standard user or a user with specific privileges can change this setting.

The peripheral printing device 100 is designed for mass production or just-in-time manufacturing. Other than the parts mounted on the printed circuit board (PCB, not shown), all parts are designed for plug-in and snap together assembly. A single screw is used to secure the interlocked parts. While the screw could also be eliminated, it provides certain advantages over a visible or invisible latch. The screw only becomes visible with the print cartridge and battery compartment cover 15/16 removed. While snap-in printer cartridges are common, the cartridge carrier is almost always attached with screws. Specially designed “fingers” 15 align and hold the cartridge in place on the bottom case piece. The printed circuit board further surrounds the print carrier and removes the chance of accidental removal. A middle case piece provides a cover over the printed circuit board to form the battery compartment 16 and also provides the print media path.

The top cover 1 provides the user removable cover to the battery 15 and ink cartridge compartment 16. The top cover 1 is secured to the bottom body member 3 and middle case member 15/16 using magnets 14. Using magnets eliminates the need for hinges, latches, or tools for removing the cover 1. The bottom body member 3 has a specially designed “T” section where front and back adapter parts interlock. This design allows a single printer case to attach to a wide variety of host devices 201. The peripheral printing device 100 can initially be used with one host device 201, and by only changing the adapter parts (upper connection member 8 and a lower connection member 9) can the peripheral printing device 100 be used with another host device 201. The adapter parts are designed to conform and grip the host device case 201. In one embodiment, they are designed to specifically not to interfere with the use of a certain host device model's mobile device power button, as well as forward and reverse facing cameras, and camera flash. The lower connection member 9 is shaped to assist the user in gripping the host device 201. The print media path 6 and the power/sleep switch 4 cover are preferably made of contrasting colored materials for easy location by the user.

Most electronics of the peripheral printing device 100, including print media motion sensors 7, are located on a single printed circuit board (PCB, not shown). While prior art peripheral printing devices have separated media sensors from the PCB of the printer controller, the uniquely shaped PCB of the present invention is able to wrap the sensors 7 and associated PCB wire traces around the print cartridge cavity 15, simplifying the construction and increasing the reliability of the peripheral printing device 100.

The PCB of the peripheral printing device 100 contains five major subsystems: (1) Microcontroller and support components, (2) battery power control and low voltage power, (3) 20V step-up voltage system, (4) printer cartridge interface, and (5) audio amplifier. The microcontroller contains a data processor, volatile and non-volatile memory, including local memory device (not shown), and analog to digital converters in electrical connection with each other, directly or indirectly. The peripheral printing device 100 is designed so that it requires only low speed analog to digital conversion for use with such functions as reading temperature and battery voltage. Because of its unique data communication method, it only requires two binary inputs for communication. The typical signal conditioning and processing used in most analog communication systems is not required. A small capacitor is used to isolate the DC voltage of the host device 201 and the peripheral printing device 100 from a first and second channel (e.g., left and right channels) of the host device's audio port 202. Bias resistors are used to set the overall amplitude range at an optimum point between 0 and 5 volts. One channel is used as a data clock and the other as data value. The binary inputs are bi-directional so they are able to generate signals as well as receive, as the host device 201 and the peripheral printing device 100 are in electrical communication through the audio port channels. This feature is used to generate audible feedback to the operator. The audio amplifier is used to send the headphone jack signal to a speaker as feedback to the operator. The feedback can originate on the host device 201 or within the peripheral printing device 100. In one embodiment, a single channel amplifier is used, since high fidelity stereo sound is not required for most applications of the peripheral printing device 100. In preferred embodiments, the speaker is plugged directly into the PCB eliminating the need for cabling. Finally, the peripheral printing device 100 also includes a more conventional serial programming port (not shown) in electrical connection with the microcontroller for use for development, maintenance, and software upgrades for the peripheral printing device 100.

A method of printing is described that uses no moving parts and reducing the size and weight, thus making the peripheral printing device 100 practical as a physically attached peripheral to small portable host devices, such as tablet computers, smart-phones, PDAs, laptops, and other portable web-enabled host devices. The technology described uses a print method that incorporates the best aspects of conventional printing technology while eliminating all moving parts.

The user slides print media along an alignment path 6 that allows the user to place the print media in the path of the print head 12. The alignment path 6 precisely fixes the relationship of the peripheral printing device 100 to the print media, regardless of the thickness. The alignment path 6 is designed to provide motion resistance as feedback to the user. In preferred embodiments, the alignment path 6 is visibly distinct from the rest of the peripheral printing device 100 to aid hand-eye coordination of the user. The alignment path 6 preferably has a distinct feel that allows print media alignment without observation. Users can use the peripheral printing device 100 with poor or no vision or visibility due to low light conditions. The print media can pass through the print area 13 in either direction with the peripheral printing device 100 automatically adjusting the print order of the pixels, so that personal preference, or specific use cases can dictate the orientation of printing.

In preferred embodiments, the peripheral printing device 100 uses a rugged replaceable industrial inkjet print cartridge that includes one or more jets for each pixel in one dimension. In two dimensional printing, the jets are arranged in a row or column in one dimension, so that as the print media is moved through the peripheral printing device 100, the same jets print multiple pixels in the other dimension. Unlike most inkjet printers, the print cartridge in the present invention remains stationary. A carrier that provides an electrical connection 19 holds the print cartridge in alignment.

Sensors 7 placed at either side of the print head 12 detect the print media entering the printing area 13. Using algorithms embedded in the peripheral printing device 100 software, the printing head 12 begins printing when the print media arrives in front of the print head 12 and stops printing within preset or margins determined on the fly as the print media passes the sensors 7. Embedded algorithms within the peripheral printing device 100 software determine the speed at which the inkjets are fired at the print media. In one embodiment, the speed is constant and the user learns the range of print media speeds that result in the desired print size. In another embodiment, the printing speed is adjustable by the user. In a preferred embodiment, the print speed is varies with the motion of the print media, adjusting automatically with the speed of the print media as it passes by the sensors 7 in the printing area 13. In more preferred embodiments, the printing speed further automatically adjusts to account for acceleration or deceleration of the print media as it passes by the sensors 7 in the printing area 13.

Some portable, web-enabled host device manufacturers lock down their operating system so that only “approved” hardware and software can interact with their host device. This is particularly problematic for technology developers whose hardware would work best directly wired to a mobile device with such restrictions. A description of a method for communicating to peripheral devices from a host device, including those with a proprietary/locked operating system is disclosed.

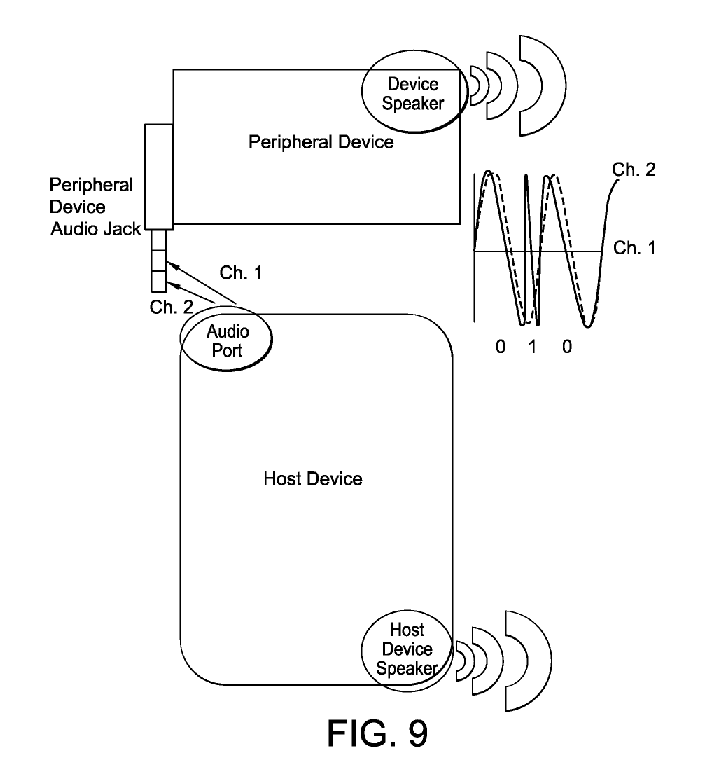

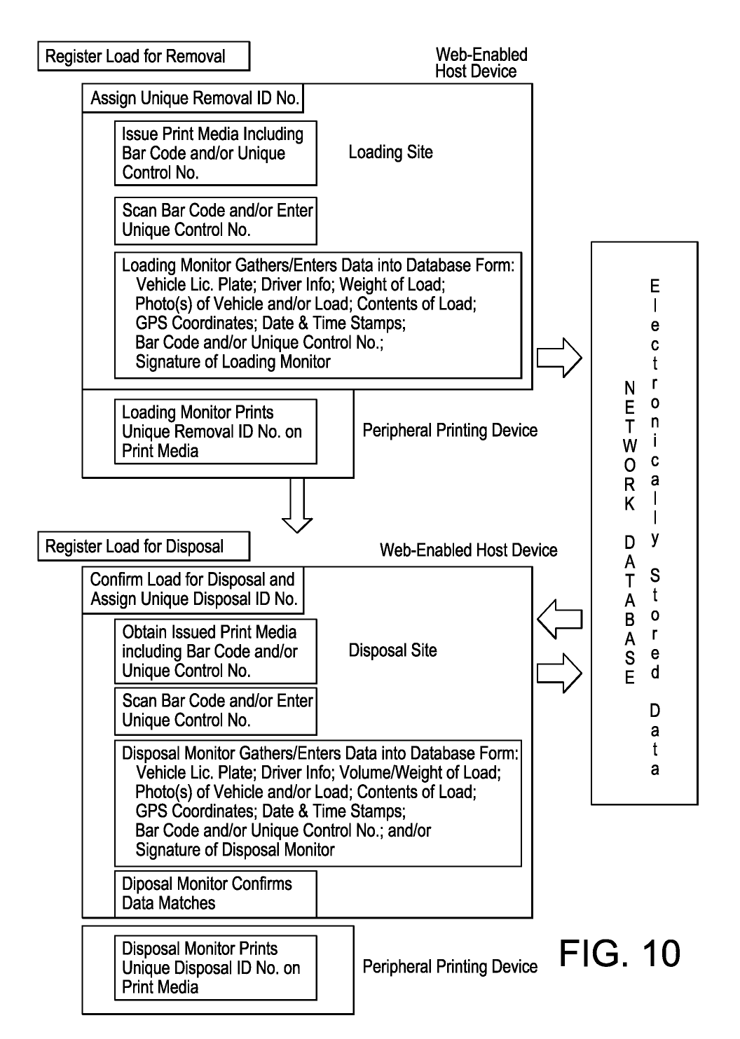

Referring now to FIG. 9, the disclosed method for communicating uses encoded waveforms to transmit data to a peripheral device, one non-limiting example embodiment of which is a peripheral printing device 100 as described herein, by using the host device's audio port 202. Since access to the audio port 202 is a basic service enabled to nearly all host services, software already present (or currently approved) on the host device, as well as remotely executed software, such as that hosted by a web site, can be used to interact with the peripheral device. This bypasses the time consuming and often costly approval process required by some host device manufacturers. The disclosed method for communicating also is capable of utilizing other wired or wireless audio ports and signals to communicate between a host device and a peripheral device 100. For example, audio signals over USB, Ethernet, HDMI, Firewire, Bluetooth®, and a number of other industry standard and proprietary protocols can be used with the disclosed communication method, even where built-in digital rights management systems are managing audio signals.

Although data has previously been transmitted using audio frequencies since the early days of telephone modems and fax machines, the disclosed method is unique, novel, and has significant advantages over other data encoding schemes.

First, most audio frequency data encoding schemes are asynchronous, and two connected devices either use a predetermined mutually agreed set of frequencies and data rates or negotiate the frequencies and protocols at the beginning of the transmission from a standardized list. The presently disclosed method is synchronous and does not require any specific frequency or data rate.

Second, most audio frequency data encoding schemes require sophisticated signal conditioning either in hardware or software. The presently disclosed method does not require any signal conditioning other than simple DC voltage isolation, so long as the signal is of sufficient amplitude. Most currently marketed devices provide sufficient amplitude through their headphone/audio port.

Third, most schemes make the audio channel un-usable or at least unpleasant for simultaneous use for human listening and data transmission. The presently disclosed method allows simultaneous audio for use for human consumption and data transmission. In one embodiment, the audio is used for audible feedback of successful barcode scans, keyboard clicking, and alarms from background applications while simultaneously transmitting data to a peripheral printing device 100.

This innovation works independently of frequency and utilizes a simple protocol that can generate and decode data without sophisticated signal processing. The signal on the sending device in its simplest implementation consists of two sine waves (i.e., a first and a second wave shape) digitally encoded as an array of numbers. A subset of this array of numbers is written to an audio buffer on the host device in such a way to transmit data. The method can work with infinitely varying waveforms, but a simple sine wave is easy to generate, and is generally passed without distortion through even the crudest audio hardware. These waves may also be generated digitally on the fly, but this would require more processing power. By creating the first and second wave shapes one time, prior to use, the host device is free to perform other tasks.

In one simple embodiment, one sine wave has a period 3 times as long as the other. So, when they are generated simultaneously, one crosses the zero point three times for every single crossing of the other. If an observer were to count using any amplitude reference as a marker, he would always count three events to one. If the observer were to include simple hysteresis rules, the count would remain accurate even with common mode and differential noise approaching 50% of the signal. Most current generation digital hardware has basic hysteresis built-in to its input circuitry. Using this counting technique, it is not particularly important to measure the amplitude or the frequency. All that is required is an observable event on one channel that is either happening at some multiple of the same event on a second channel, or not. The “not” condition can be assigned a value of zero ‘0’, and the multiple count condition a value of one ‘1’. Arranging the array of numbers placed in the audio buffer in a specific order can produce a specific set of counting events that is very simply translated into ones and zeros.

When data is transmitted, the longer period wave is transmitted on one audio channel and simultaneously either a matching wave or its multiple version is transmitted on the second channel. Both channels with identical waves corresponds to one value, while a number of waves occurring during the same period as a single wave on the first channel represents a different number. In the simplest implementation, a matching wave corresponds to a value of zero and a non-matching wave corresponds to a value of one. This implementation provides for serial data transition of binary data using a very simple algorithm. The transmission is robust and can withstand variations in frequency and shape due to pre-emptive processes outside of the applications control. It is only necessary that the wave forms periods maintain their relationship to each other. While this simple implementation is described for binary serial transmission (base 2), the technique can also be used with other bases (base 10 and base 16 being especially useful for some applications). Of course, still higher bases can be used, depending on the information and data being transmitted and the application. For example, a 3× multiple period may represent a ‘1’, a 4× multiple may represent a ‘2’, and so forth. It should be appreciated that using higher bases for communicating can be more practical by significantly compressing the time required to transmit the data to and from the peripheral device 100.

Other advantages of the disclosed communication method include: 1) mobile systems hardware and software change often and sometimes dramatically, sometimes receiving major software upgrades over their lifetimes. The device's audio capabilities will always remain within a certain envelope; and 2) the audio port can continue to be used for audio feedback to the operator. Rather than data sounding like static or a broken radio, pleasant tones or even cords and melodies can include data.

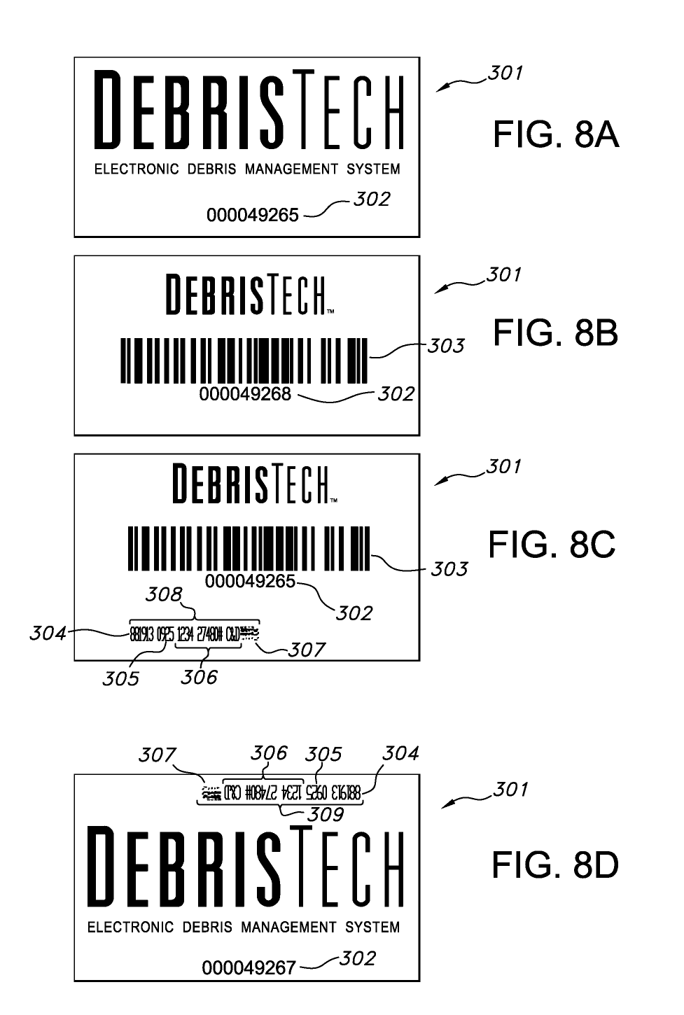

Referring now to FIGS. 8A-D & 10, a system and method of tracking the shipment of goods or the consumption of services is disclosed by discussing an exemplary embodiment in which the system and method are used to manage debris removal and disposal using the peripheral printing device 100 of the present invention. Once a debris site (Loading Site) is readied for debris removal, a Loading Monitor will register a load of debris for removal from the Loading Site. The Loading Monitor will assign the load a unique removal ID number 308 by using a portable web-enabled computing device 201, such as a tablet computer, smart-phone, PDA, laptop, or other computing device. The Loading Monitor first issues a print media 301, e.g., a load or deposit ticket, for the load to be removed. The print media 301 can include a unique one-dimensional code for scanning 303 (e.g., a bar code) and/or a unique control number 302. In preferred embodiments, the system and method employ a unique one- or two-dimensional code for scanning 303 and a unique control number 302.

The Loading Monitor will then scan the code 303 using the portable web-enabled computing device 201 or enter into the portable web-enabled computing device 201 the control number 302 on the print media 301 to initiate data collection for registering the load for removal. Using the portable web-enabled computing device 201, the Loading Monitor enters data into a database form, including the information concerning the vehicle, driver, the load for removal (weight, contents, etc.), digital photographs of the vehicle and/or load, confirms the scan code 303 and/or the control number 302 match on the portable web-enabled computing device 201 screen, and digitally signs the database form (“electronically stored data”). In preferred embodiments, the system software automatically captures further electronically stored data of the GPS coordinates, date, and time of the loading site when the Loading Monitor confirms the data was entered correctly. The electronically stored data is thereby associated with the code for scanning 303 and/or the control number 302 for the load for removal located on the issued print media 301. The system then automatically and in real-time communicates over a network with a remote network database, such as a remote server, to store the electronically stored data in the remote network database and make it accessible to other users in the network, including other users equipped with another portable web-enabled computing device 201 using the peripheral printing device 100. The portable web-enabled computing device 201 can use a variety of communication means to be in network communication with the remote network database, including, but not limited to known means such as WiFi, Bluetooth®, cellular networks, and other radio frequency bandwidths. In case network communication is interrupted, such as a low network signal or the user is out of range for a network signal, the system stores all data in a local memory as backup. The local memory is in electrical communication with the microcontroller and may be in the peripheral printing device 100 or in the portable web-enabled computing device 201. Preferably, the local memory is located in the peripheral printing device 100 and in electrical communication with the microcontroller. Once communication over the network is restored, the electronically stored data that is temporarily stored locally is transferred to the remote network database to make it accessible to other users in the network.

Once the Loading Monitor has entered and confirmed the electronically stored data, the system software automatically issues a unique shipment ID number, e.g., a unique removal ID number 308, for the load of debris for removal. The issued unique removal ID number 308 for the load of debris for removal is thereby associated with the code for scanning 303 and/or the control number 302 for the load for removal located on the issued print media 301. The Loading Monitor then prints on one side of the print media 301 the unique removal ID number 308 using the peripheral printing device 100. The printing can be done on either side of the print media 301, but should ordinarily only be printed once on the print media 301. In preferred embodiments, the peripheral printing device 100 has been assigned a unique code, which along with other real-time data, generates a unique matrix pattern 307 that the peripheral printing device 100 automatically prints on the print media 301 as an additional anti-fraud feature. The load type and measure (i.e. “tree stump at 36 inches”) may also be printed on the media as a human readable pickup receipt. The load for removal can then be released for transport to the disposal site.

Once the vehicle hauling the load of debris has reached the place for delivering the load (Disposal Site or Delivery Site), the load can now be referred to as the load of debris for disposal. A Disposal Monitor will obtain the print media 301 issued for the load at the loading site. The electronically stored data associated with the debris load and represented by the print media 301 is communicated over a network to the Disposal Monitor's portable web-enabled computing device 201 of the system automatically once the Disposal Monitor scans the code 303 using the portable web-enabled computing device 201 or enters into the portable web-enabled computing device 201 the control number 302 on the print media 301. The Disposal Monitor can then confirm that the load for disposal is the correct load associated with the print media 301 obtained. Optionally, the Disposal Monitor will independently gather and enter data into a database form, including the information concerning the vehicle, driver, the load for disposal (weight, contents, etc.), digital photographs of the vehicle and/or load, confirms the scan code 303 and/or the control number 302 match on the portable web-enabled computing device 201 screen, and digitally signs the database form (“electronically stored data”). In preferred embodiments, the system software automatically captures the GPS coordinates, date, and time, and the unique identity of the computing device (“electronically stored data”) of the disposal site when the Disposal Monitor confirms the data was entered correctly. The electronically stored data is thereby associated with the code for scanning 303 and/or the control number 302 for the load for disposal located on the issued print media 301. The system then automatically and in real-time communicates over a network with a remote network database to store the electronically stored data and make it accessible to other users in the network.

Once the Disposal Monitor has entered and/or confirmed the electronically stored data, the system software automatically issues a unique delivery ID number, e.g., a unique disposal ID number 309, for the load of debris for disposal. The issued unique disposal ID number 309 for the load of debris for disposal is thereby associated with the code for scanning 303 and/or the control number 302 for the load for disposal located on the issued print media 301. The Disposal Monitor then prints on a second side of the print media 301 the unique disposal ID number 309 using the peripheral printing device 100. The printing can be done on either side of the print media 301, but should ordinarily only be printed once on the print media and on the opposite side used for printing the unique removal ID number 308. In preferred embodiments, the peripheral printing device 100 generates a unique matrix pattern 307 that it automatically prints on the print media 301 as an additional anti-fraud feature. The load measure can also be printed as a human readable delivery receipt for the driver. The load for disposal can then be released for dumping at the disposal site.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A system comprising a web-enabled host device, a remote network database in network communication with the web-enabled host device, and the peripheral printing device of claim 10 in electrical communication with the web-enabled host device.

2. The system of claim 1, wherein the web-enabled host device is a plurality of web-enabled host devices and the peripheral printing device is a plurality of peripheral printing devices, and wherein each of the plurality of peripheral printing devices is separately in electrical communication with one of the plurality of web-enabled host devices.

3. The system of claim 2, wherein the remote database stores data collected at each of the plurality of web-enabled host devices.

4. The system of claim 3, wherein each of the plurality of web-enabled host devices in separate electrical communication with one of the plurality of peripheral printing devices is in network communication with the remote database.

5. The system of claim 4, wherein at least one of the plurality of web-enabled host devices in separate electrical communication with one of the plurality of peripheral printing devices is positioned at a loading site and at least one of the plurality of web-enabled host devices in separate electrical communication with one of the plurality of peripheral printing devices is positioned at a delivery site.

6. A method for tracking a shipment of goods from a loading site to a delivery site comprising:
providing a peripheral printing device of claim 10, wherein the peripheral printing device is in electrical communication with a web-enabled host device;
receiving a scan of an issued load ticket at the loading site, wherein the issued load ticket comprises at least one of the group consisting of a unique bar code for scanning and a unique control number;
receiving a set of information concerning the shipment of goods, wherein the set of information comprises at least one of the group consisting of a vehicle identification, a driver identification, a weight of the shipment of goods, a content description of the shipment of goods, a digital photograph of the vehicle, a digital photograph of the driver, a digital photograph of the shipment of goods, a set of GPS coordinates for the loading site, a date, and a time;
generating a unique removal ID number for the shipment of goods;
generating a unique matrix pattern based on the peripheral printing device and the set of information;
storing the set of information, the unique removal ID number, and the unique matrix pattern in a remote network database; and
printing the unique removal ID number and the unique matrix pattern on the issued load ticket.

7. The method of claim 6 further comprising the step of associating the set of information with the at least one of the group consisting of a unique bar code for scanning and a unique control number.

8. The method of claim 6 further comprising the step of associating the unique removal ID number with the at least one of the group consisting of a unique bar code for scanning and a unique control number.

9. The method of claim 7 further comprising the step of receiving a scan of an issued load ticket at the delivery site.

10. The method of claim 8 further comprising the step of receiving a scan of an issued load ticket at the delivery site.

11. The method of claim 9 further comprising the step of electronically confirming the shipment of goods at the delivery site by crosschecking the issued load ticket with the set of information, the unique removal ID number, and the unique matrix pattern stored in the remote network database.

12. The method of claim 10 further comprising the step of electronically confirming the shipment of goods at the delivery site by crosschecking the issued load ticket with the set of information, the unique removal ID number, and the unique matrix pattern stored in the remote network database.

13. The method of claim 11 further comprising the steps of generating a unique delivery ID number for the shipment of goods and printing the unique delivery ID number on the issued load ticket.

14. The method of claim 12 further comprising the steps of generating a unique delivery ID number for the shipment of goods and printing the unique delivery ID number on the issued load ticket.

15. A peripheral printing device comprising a body, an electrical and data connector, at least one connection member for attaching to a web-enabled host device, a print head, and a plurality of print media sensors.

16. The peripheral printing device of claim 15 further comprising a microcontroller and a local memory device in electrical connection with each other.

17. The peripheral printing device of claim 16 further comprising an onboard power source.

18. The peripheral printing device of claim 17 further comprising an alignment path for print media to move in front of the print head.

19. The peripheral printing device of claim 18, wherein the at least one connection member for attaching to a web-enabled host device comprises an upper connection member and a lower connection member.

20. The peripheral printing device of claim 18, wherein the plurality of print media sensors comprises a first sensor and a second sensor, and wherein the first sensor is disposed in the alignment path on a first side of the print head and the second sensor is disposed in the alignment path on a second side of the print head.

21. The peripheral printing device of claim 18 further comprising an audio amplifier, a speaker, and a LED indicator.

22. The peripheral printing device of claim 18 further comprising a serial programming port in electrical connection with the microcontroller.

23. A method of communication between a web-enabled host device and a peripheral device comprising the steps of:
providing said peripheral device, wherein said peripheral device is capable of being in electrical communication in at least two channels with said web-enabled host device by an audio port connection;
creating a first wave shape by said web-enabled host device to pass through a first channel and a second channel to said peripheral device, wherein said first wave shape has a first period;
creating a second wave shape by said web-enabled host device to pass through said second channel to said peripheral device, wherein said second wave shape has a second period that is a multiple of said first period;
sending said first wave shape to said peripheral device from said web-enabled host device through said first channel;
sending said first wave shape and second wave shape to said peripheral device from said web-enabled host device through said second channel thereby creating a string of matching and nonmatching periods for said first and said second channels; and
analyzing said string of matching and nonmatching periods for said first and said second channels as a digital signal.

24. The method of claim 23, wherein said first wave shape and said second wave shape are sine waves.

25. The method of claim 23, wherein the steps of creating said first wave shape and creating said second wave shape are performed by said web-enabled host device prior to use of communicating with said peripheral device.

26. The method of claim 23, wherein said digital signal is binary.

27. The method of claim 23, wherein said digital signal is base 10.

28. The method of claim 23, wherein said digital signal is base 16.

29. The method of claim 23 further comprising the step of sending an audio signal to said peripheral device through said first and said second channels while simultaneously performing the steps of sending said first wave shape to said peripheral device and sending said first wave shape and second wave shape to said peripheral device.

30. The method of claim 29, wherein said audio signal is an audio feedback signal.
